(19) United States
(12) Patent Application Publication
(10) Pub. No.: US 2003/0223387 A1
(43) Pub. Date: Dec. 4, 2003

(54) Remote vehicle communication associate

(76) Inventors: David Michael Davenport, Niskayuna, NY (US); Carl Frederick Conrath, Erie, PA (US); Glenn Robert Shaffer, Erie, PA (US); Ralph T. Hoctor, Saratoga Springs, NY (US); John Erik Hershey, Ballston Lake, NY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/160,490

(22) Filed: May 31, 2002

(51) Int. Cl. H04Q 7/00; H04J 3/24

(52) U.S. Cl. 370/328; 370/349

(57) ABSTRACT

A communication apparatus for allowing a first remote asset to communicate with wayside device, a second remote asset, a remote facility and a central operations facility, the apparatus comprising a local area network module for sending and receiving a communication over a short range using a local area network, a wide area network module for sending and receiving a communication over a long range using a wide area network, a control module to control communications sent and received over at least one of said local area network and said wide area network, and a coordinate module to coordinate a communication sent and received from a sensor wherein the apparatus passes the communication between the first remote asset and at least one of the wayside device, the second remote asset, the remote facility and the central facility based on at least one of a coverage area, latency, and a predetermined function.

### BACKGROUND OF THE INVENTION

This invention relates to a communication system, and more specifically to an apparatus and method for communicating from a mobile asset to wayside devices and remote facilities over both a wide area network and a local area network.

Many individual mobile assets, such as trains, cars, trucks, airplanes, travel over vast geographic regions. During these travels, any of these assets may experience a need to communicate with devices or individual they pass while traveling or with central facilities, which may monitor the mobile assets' operations. Such communications may occur over local area networks when the device to be communicated with is within a local area or over a wide area network when the device to be communicated with is at a great distance from the asset.

Typically, independent communication devices are used to communicate over either a wide area network or a local area network. Additionally, other independent devices are used for processing data that may be sent over either a wide area network or a local area network. For example, with respect to a train with at least one locomotive, sensors may be available aboard the train to monitor systems and operating conditions. This data is relayed to a processor to compile this data and possibly sent to a device or facility remote from the train. In other embodiments, an independent communication device sends the compiled data. However, in all such embodiments, all communication devices, and data compilers are independent devices that generally function independent of each other. Operators of such remote assets would benefit from a device that could perform all communication functions where the device would determine which network to operate over while also scheduling sending data that is compiled either by the device or by an external device.

### BRIEF DESCRIPTION OF THE INVENTION

Towards this end, the present invention a communication apparatus for allowing a first remote asset to communicate with either a wayside device, a second remote asset, a remote facility or a central facility. The apparatus comprises a local area network module for sending and receiving a communication over a short range using a local area network, a wide area network module for sending and receiving a communication over a long range using a wide area network, a control module to control communications sent and received over at least one of the local area network and the wide area network, and a coordinate module to coordinate a communication sent and received from a sensor. The apparatus passes the communication between the first remote asset and at least one of the wayside devices, the second remote asset, the remote facility, and the central facility based on at least one of a coverage area, latency, and a predetermined function.

The present invention also discloses a method for communicating between a first remote asset, a wayside device, a second remote asset, a remote facility or a central operations facility. The method comprises providing a communication apparatus operable to communicate over a wide area network and a local area network based on based on at least one of a coverage area, latency, and a predetermined function. The method further comprises communicating with a wayside device where a communication occurs between the first remote asset and the wayside device over a local area network. Communicating with a remote facility where a communication occurs between the first remote asset and the remote facility over a local area network is also provided. Additionally, communicating with the central facility where a communication occurs between the first remote asset and the central facility over the wide area network is provided. Finally, the method provides for communicating with the second remote asset where a communication occurs between the first remote asset and the second remote asset over a local area network.

### BRIEF DESCRIPTION OF THE DRAWINGS

The features of the invention are set forth with particularity in the appended claims. The invention itself, both as to organization and method of operation, may best be understood by reference to the following description in conjunction with the accompanying drawings in which like numbers represent like parts throughout the drawings and in which:

FIG. 1 is a block diagram of an exemplary communication system illustrating communication paths in accordance with the present invention;

FIGI. 2 is a block diagram of exemplary modules that are part of the communication system in accordance with the present invention;

FIG. 3 is a simplified block diagram of an exemplary communication scheme between two trains; and

FIG. 4 is a simplified block diagram of the communication apparatus in operation.

### DETAILED DESCRIPTION

With reference to the figures, exemplary embodiments of the invention will now be described. The scope of the invention disclosed is applicable to a plurality of remote assets, which are or are not part of a fleet, such as, but not limited to, automobiles, trucks, planes, locomotives, etc. For illustration purposes only, this invention is being disclosed with reference to locomotives. Thus, even though embodiments are described specific to locomotives, one skilled in the art will recognize how the invention is also applicable to other remote assets.

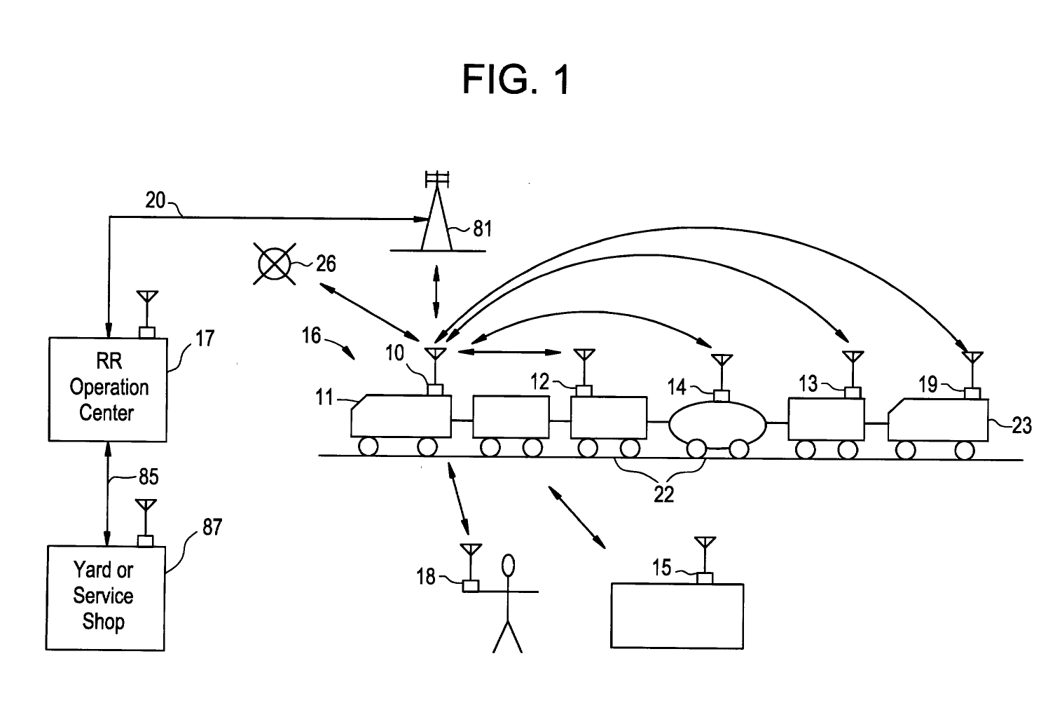

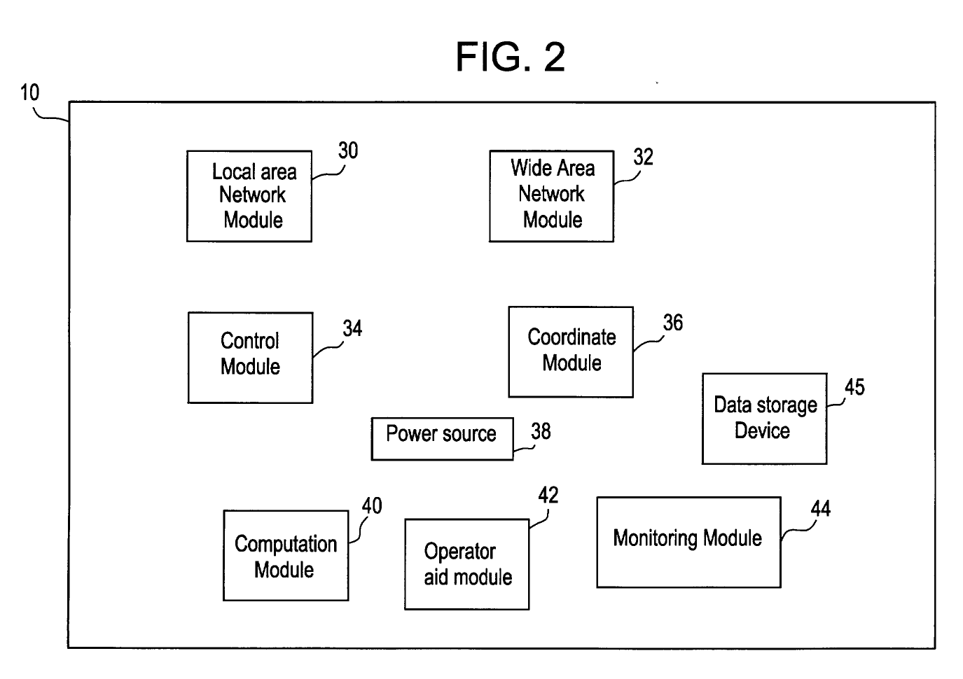

FIG. 1 is a block diagram of an exemplary communication system illustrating communication paths in accordance with the present invention. FIG. 1 illustrates a train, which consists of a first and second locomotive, and a plurality of cars. A remote asset communication associate, or component, 10 is located on a first locomotive 11. The communication associate or component 10 performs both local area network and wide area network communications. In one embodiment, the communication associate 10 also stores information in a database, perform computations, and other storage functions. The communication associate 10 is capable of communicating over a wide area network to a remote facility such as a railroad operations center 17. The wide area network operates over a variety of communications options. Such examples include extant right-of-way communications infrastructure, such as a UHF communication link 81, which is backhauled 20 to the railroad communications center 17. Another option is by way of satellite communications 26, using either geostationary satellites, medium earth-orbit satellites, low-earth orbit satellites or a combination of these satellites, where the satellite communication link 26 is backhauled to the operation center 17 via terrestrial land line or satellite and RF link. This backhaul is not shown in FIG. 1. The communication is then linked 85 between the operation center 17 and a remote facility 87, such as a service shop, rail yard, and/or depot. This backhaul is not shown in FIG. 1.

The communication associate 10 also has the ability to communicate, typically over a local area network, with either a wayside device 15 or with a wayside worker 18 or with a facility, such as a railroad yard, fuel depot, service shop facility, etc. when in close proximity with such facility. In communicating with a wayside device 15, worker 18, or facility 87, the communication associate 10 can interact with the wayside device or worker or facility to relay messages from the railroad operations center 17 to and from the wayside device 15 or worker 18. Such local area network communications with the worker 18 may involve use of a communication device such as a hand-held computer or some other communication device.

The communication associate 10 can also relay messages between wayside device 15 and worker 18, or between wayside device 15 and other wayside device (not shown) or between worker 18 and other workers (not shown). In other words, the present invention allows for messages to be passed between any wayside device or worker using the locomotive as either a physical transport or having the locomotive pass the message to another locomotive traveling in different direction, or having the locomotive pass the message to the central office which could reroute the message to another loco in the vicinity or approaching the desired wayside recipient. This is in effect a dynamic, intelligent store and forward communication approach to exchange of data throughout the railroad environment.

The communication associate 10 can also forward reports concerning the functions or defective conditions of a wayside device, discerned by monitoring the device that may be separate from this device and possibly located on the locomotive 11. Such wayside devices 15 can include, but are not limited to, railroad crossing signals, track switches, etc. With respect to a wayside worker, the communication associate can provide communications to and from the wayside worker 18 to assist in a task. A task may include, but is not limited to, local work order entry and retrieval, including local provision and access to electronically stored manuals for performing wayside operations tasks, and “blue flag” sign in/sign out functions. “Blue flag” is a term used for safety procedures. When a worker is working on a locomotive 11, for example, under a locomotive 11, there is a blue flag that is posted. Thus, as long as the blue flag, or blue marker, is posted or displayed, the locomotive 11 cannot be moved.

In another preferred embodiment, the present invention could also use the locomotive to distribute time updates via on-board GPS and wireless local area network to wayside objects and personnel, which may not possess GPS time references. This time synchronization benefits RF communication oscillators, work crew scheduling, etc.

The communication associate 10 will also communicate with sensors 12, 13, 14 located on the train. For example, if a train 16 included cars 22 containing toxic materials, the communication associate would communicate with a HAZMAT sensor 14 or sensor packages that would detect leaks of the toxic materials from their host rail cars 22. In another example, other remote instruments 12, 13, or special instrument satchels, such as accelerometers that measure vibration and track compliance/bending, in order to help assess the condition of the rail bed and the condition of the rails, would also be able to communicate with the communication associate. The communication associate 10 would then be equipped with the necessary signal processing routines, or control module, to accomplish real-time reduction of the data and a summary of the data or summary by exception, which would then be reported to the railroad operations center 17. In a preferred embodiment, the communications associate 10 has a large capacity data logging capability with memory back-up afforded by electrical system of the locomotive. This would allow sensors on board individual cars to be smaller and consume less energy. The communication associate 10 is expandable and scalable in its processor capabilities and communications interface capabilities to participate in expanding computation and communications tasks required to integrate and support functions required by support functions required by advanced radio based train control or synthetic signaling.

When multiple locomotives 11, 23 are part of the same train 16, the communication associate 10 on each locomotive 11, 23 may operate together for greater efficiency and for greater communications reliability and/or availability. As an example, multiple communication associates 10, 19 in a train 16 can coordinate the retrieval data from all locomotives 11, 23 and avoid individual retrieval from each locomotive, thus reducing cost and possibly leveraging the communication associate 10, 19 with different wireless communications links. As another example, multiple communication associates 10, 19 on a train 16 can also coordinate and select the locomotive 11, 23, or communication associate 10, 19, offering the best signal strength for a given transmission. For example, consider a one-mile long train 16 winding through mountains. If an urgent message must be sent, such as one indicating an alarm state, and the lead locomotive 11 is blocked from all wireless wide area links, if the trailing locomotive 23 has a clear view for communicating with a satellite 26, then the trailing locomotive 23, or communication associate 19, can act for the lead locomotive 11, or communication associate 10, where the wireless local area network connection between locomotive 11 and 23 is the key enabler for this functionality.

FIG. 2 is a block diagram of exemplary modules or elements that are part of the communications system or communication associate in accordance with the present invention. In a preferred embodiment, the communications system has a local area network module 30, a wide area network module 32, a control module 34, a coordinate module 36 and power source 38. Other preferred embodiments may also include a computation module 40, an operator aid module 42, a monitoring module 44, and/or a data storage device 45. Even though the invention is disclosed as having modules, devices or elements, one skilled in the art will realize that these modules can be combined in any variety of combinations, where a single module, device or element can perform various functions disclosed herein.

As discussed previously, the local area network module 30 is capable of communicating over a variety of wireless options, such as 802.11 wireless Ethernet, BlueTooth, HIPERLAN, Ultra Wide Band (UWB), etc. The local area network 30 module has the requisite software and hardware to communicate over all available wireless options for communicating over the local area network. Communication over the local area network is used for communicating with the wayside devices 15, wayside workers 18, and sensors and/or communications devices 12, 13, 14, 19 located elsewhere on the train 16, including other communication associates 19. In one preferred embodiment, communicating with sensors 12, 13, 14 and other communication associates aboard the train will occur over a predetermined network or when a predetermined function is recognized. Communicating with either wayside workers 18 or devices will vary between a local area network and wide area network, based on a geographic location of the train, latency, and/or a predetermined function. In other preferred embodiments, the communication with sensors on a train 16 will not be over a predetermined network.

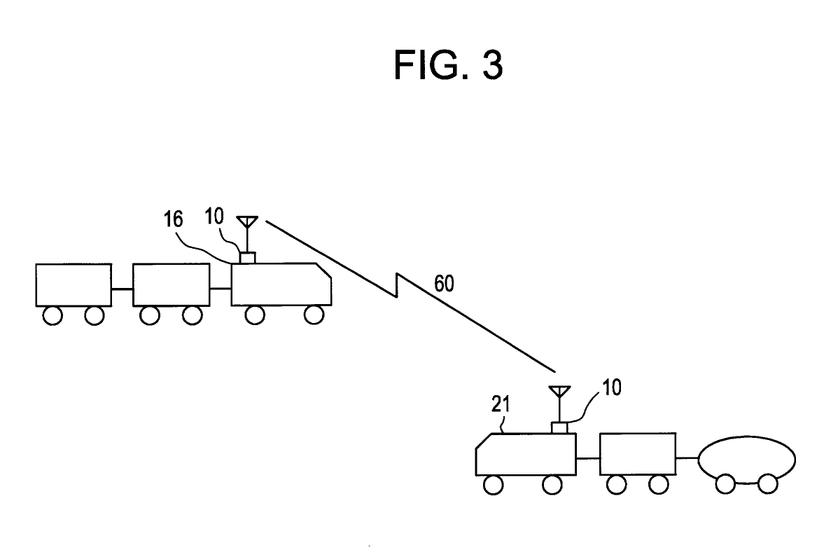

The local area network module 30 can also be used to communicate with other trains 21 that are located close by as illustrated in FIG. 3. For example, if two trains 16, 21 are passing each other, one traveling west while the second is traveling east, these trains 16, 21 could exchange data 60 from one another and even data received from wayside devices 15 and wayside devices held by wayside people 18 that each respective train 16, 21 had encountered in its recent past. Similarly, the local area network could be used to pass data from one wayside device 15 to a second wayside device 15. Again, referring to the two trains 16, 21 communicating in passing, suppose the eastbound train 16 would like to relay a message to either a wayside device 15 or individual 18 that it had passed previously, based on new information learned. Instead of accessing a wide area network, which is potentially more expensive to use, the eastbound train 16 could relay 60 the information or message to the westbound train 21, where the westbound train would then deliver the message over its local area network upon being in range of the intended recipient.

Because of the limited time available for communication between a moving communications network node, such as a locomotive and a stationary one, a local area network channel access protocol must be chosen that guarantees the full use of every available time slot. This consideration rules out systems like ALOHA, or carrier-sense multiple access schemes with collision detection, since all of these systems allow destructive packet collisions. The present invention makes use of non-destructive channel access protocols, such as that utilized by the controller area network (CAN) protocol, which uses distributed packet priority arbitration to make sure that a data packet is transmitted in every time period.

As previously discussed, the wide area network module 32 would allow for communications over either a satellite network, a VHF communications network, or any other type of wide area network. This network would primarily be used to communicate with the railroad operations center 17. The power source 38 would provide power to operate the communication associate. This power source 38 can be derived either from the locomotive 11, or can be an independent power source 38. The power source 38 can be either AC-based or DC-based. In one embodiment, the primary source 38 has a backup power source, such as a battery.

The coordinate module 36 will coordinate the retrieval of data from other communication associates 19 if the train comprises a plurality of locomotives 11, 13, each containing a communication associate 10, 19, as well as data being transmitted from sensors 12, 13, 14, as previously discussed with respect to FIG. 1. The data is stored in the data storage device 45. A control module 34 will coordinate and make a determination as to whether to use the local area network module 30 or wide area network module 32 to transmit the data. In a preferred embodiment, the determination is selected on the basis of coverage, latency, cost and/or a specific task or function being performed. The monitoring module 44 is provided to monitor sensor packages or sensors 12, 13, 14, such as the HAZMAT sensor 14 and/or other sensors 12, 13 located upon the train 16. The computation module 40 will contain the necessary signal processing routines to accomplish real-time data reduction, summary of the data or summary by exception, which may then be reported to the railroad operations center or to a wayside worker. The operator aid module 42 will include devices to allow an operator to monitor the activities of the communication associate 10. Such aids include, but are not limited to, visual displays, annunciators, digitized speech modules, etc.

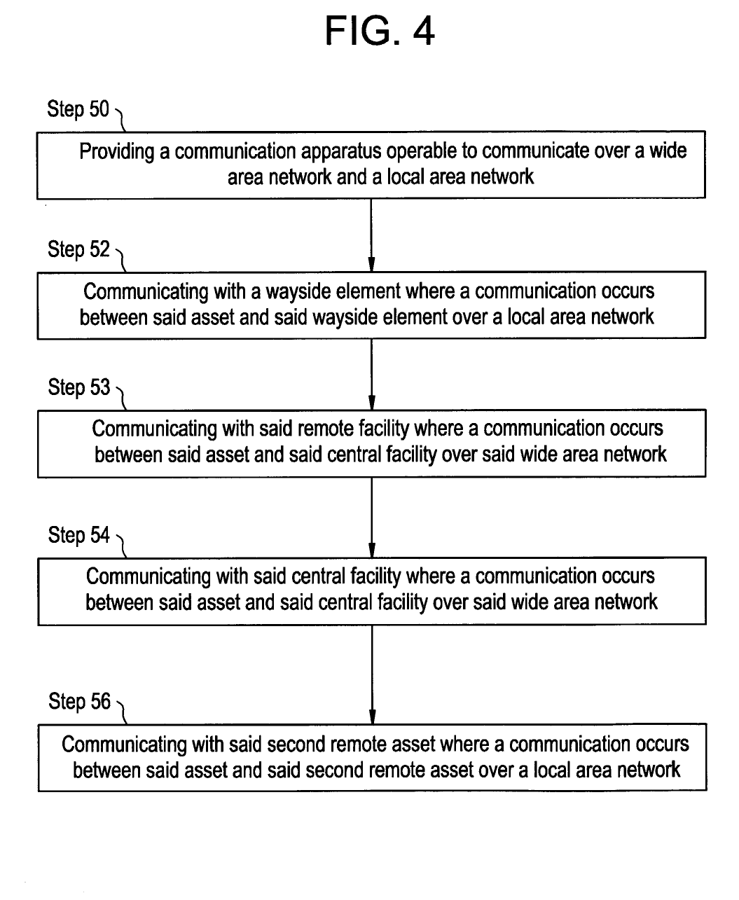

In operation as illustrated in FIG. 4, a communication apparatus is provided that is operable to communicate over a wide area network and a local area network, step 50. The communication apparatus communicates with a wayside element where a communication occurs between the asset and the wayside element over a local area network, step 52. The communication apparatus communicates with the remote facility where a communication occurs between the asset and the central facility over the wide area network, step 53. The communication apparatus also communicates with the central facility where a communication occurs between the asset and the central facility over the wide area network, step 54. The communication apparatus also communicates with the second remote asset where a communication occurs between the asset and the second remote asset over a local area network, step 56. More specifically, the communication apparatus allows for a remote asset to communicate with various objects which may have various communication protocols where the communication with the various objects occurs at the same time.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

What is claimed is:

1. A communication apparatus for allowing a first remote asset to communicate with a wayside device, a second remote asset, a remote facility and a central facility, said apparatus comprising:
(a) a local area network module for sending and receiving a communication over a short range using a local area network;
(b) a wide area network module for sending and receiving a communication over a long range using a wide area network;
(c) a control module to control communications sent and received over at least one of said local area network and said wide area network;
(d) a coordinate module to coordinate a communication sent and received from a sensor;
(e) wherein said apparatus passes said communication between said first remote asset and at least one of said wayside devices, said second remote asset, said remote facility, and said central facility based on at least one of a coverage area, latency, and a predetermined function.

2. The apparatus of claim 1 wherein said local area network module and said wide area network module are a single module.

3. The apparatus of claim 1 wherein said control module and said coordinate module are a single module.

4. The apparatus of claim 1 wherein said communications over at least one of said local area network module and said wide area network module are encrypted.

5. The apparatus of claim 1 wherein a communication using at least one of said local area network module and said wide area network module is protected by an authentication code.

6. The apparatus of claim 1 further comprising a computation module to compute data received from a remote sensor before sending said computed data over at least one of said local area network and said wide area network.

7. The apparatus of claim 1 further comprising a monitoring module to monitor data received from a remote sensor.

8. The apparatus of claim 1 further comprising a power source.

9. The apparatus of claim 1 further comprising a data storage device.

10. The apparatus of claim 1 further comprising an operator aid module.

11. The apparatus of claim 1 wherein said remote vehicle transmits information to a second remote vehicle when said first remote vehicle passes said second remote vehicle.

12. A method for communicating between at least one of a first remote asset, a wayside device, a second remote asset, a remote facility and a central operations facility, said method comprising:
(a) providing a communication apparatus operable to communicate over a wide area network and a local area network based on based on at least one of a coverage area, latency, and a predetermined function;
(b) communicating with a wayside device where a communication occurs between said first remote asset and said wayside device over a local area network;
(c) communicating with a remote facility where a communication occurs between said first remote asset and said remote facility over a local area network;
(d) communicating with said central facility where a communication occurs between said first remote asset and said central facility over said wide area network;
(e) communicating with said second remote asset where a communication occurs between said first remote asset and said second remote asset over a local area network.

13. The method of claim 12 further comprising monitoring a remote sensor.

14. The method of claim 12 further comprising computing data received from said remote sensor.

15. The method of claim 12 further comprising providing an operator aid to allow an operator to monitor a communication.

16. The method of claim 12 further comprising the use of a nondestructive channel access protocol for the local area network.

17. The method of claim 12, further comprising the use of a controller area network (CAN) protocol for the local area network.
